(19) United States
(12) Patent Application Publication
(10) Pub. No.: US 2006/0269106 A1
(43) Pub. Date: Nov. 30, 2006

(54) System and method for optimizing throughput of medical evidence data to and from long term digital storage solutions

(75) Inventors: Wilbert Staring, Ha Duiven (NL); Jorrit Poelen, Utrecht (NL); Jaap Stramrood, Velp (NL); Andries Hamster, Zeist (NL)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/141,142

(22) Filed: May 31, 2005

(51) Int. Cl. G06K 9/00; G06Q 10/00

(52) U.S. Cl. 382/128; 705/2

(57) ABSTRACT

Certain embodiments of the present invention provide an improved system and method for reducing transfer overhead of medical evidence data to a storage device. Certain embodiments of the method include determining an image count for a medical study including one or more images and comparing the image count for the medical study to image counts for other medical studies to be transferred to calculate a relative image count. Certain embodiments include identifying availability of computing resources, allocating available computing resources to the medical study based on the relative image count, and transferring the medical study using the allocated computing resources. In an embodiment, more computing resources are allocated to a medical study with a high relative image count than to a medical study with a low relative image count. Available computing resources may be selectively allocated based on relative image count to reduce transfer overhead.

### RELATED APPLICATIONS

Not Applicable

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention generally relates to storage of medical image data. In particular, the present invention relates to a system and method for storage of medical image data based on medical image data characteristics.

Healthcare environments, such as hospitals or clinics, include clinical information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided among a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

Current medical information storage and management systems store and/or process large amounts of data. Additionally, medical data being processed and/or stored by medical information storage and management systems changes frequently. The large volume of data places a heavy burden on the systems processing and/or storing the data.

Many vendors in the medical imaging industry have established a communication standard to allow medical image data to be transmitted and processed by a plurality of disparate systems. One common standard is the Digital Imaging and Communications in Medicine (DICOM) protocol. DICOM is a standard for image and information transmission. DICOM relates to the transfer of electronic data between medical diagnostic and imaging systems. The DICOM protocol may be employed in communication between medical devices and image archives, such as PACS.

The DICOM standard enumerates a command set, data formats, interface specifications, communication protocols, and command syntax. However, the DICOM standard does not specify details of implementation. DICOM sets forth Information Objects (types of data, such as computerized tomography, magnetic resonance, x-ray, ultrasound, etc.), Service Classes (actions with data, such as send, receive, print, etc.), and data transmission protocols. The Service Class User (SCU) protocol governs use of the DICOM service. The Service Class Provider (SCP) protocol governs the provider of the DICOM service.

The DICOM protocol, such as the DICOM 3.0 protocol, is the standard digital communication protocol in radiology, cardiology and other medical imaging disciplines. The DICOM data model is organized in roughly three levels: a study level, a series level and an image level. For example, a series may be a group of images and a study may be a group of series. On a storage device, a study may include one or more image files. The image files include information related to the study and series of specific image(s).

Medical evidence data is stored and transferred for storage and viewing purposes. A transfer throughput of a medical study to a storage device depends on an amount of images in the study. Given that a total byte-size of a study is constant, the transfer throughput of the study decreases as the amount of images in the study increases. For example, if a first study includes ten images and a second study includes one hundred images, then the throughput of the second study is lower than the throughput of the first study, provided that the studies have identical total byte-size. The disparity in throughput is caused by the overhead of handling individual files, for example.

Thus, there is a need for a system and method for reducing transfer overhead of medical evidence data to that the total transfer throughput of a DICOM study approaches the total transfer bandwidth of the storage device.

### BRIEF SUMMARY OF THE INVENTION

Certain embodiments of the present invention provide an improved system and method for reducing transfer overhead of medical evidence data to a storage device. Certain embodiments of the method include determining an image count for a medical study including one or more images and comparing the image count for the medical study to image counts for other medical studies to be transferred to calculate a relative image count. Certain embodiments include identifying availability of computing resources, allocating available computing resources to the medical study based on the relative image count, and transferring the medical study using the allocated computing resources.

In an embodiment, the method further includes allocating more computing resources to a medical study with a high relative image count than to a medical study with a low relative image count. The method may include selectively allocating available computing resources based on relative image count to reduce transfer overhead. In certain embodiments, the medical study is transferred for storage and/or for display. The medical study may be transferred using the DICOM protocol, for example. In an embodiment, the method may further include reallocating computing resources upon completion of the transfer of the medical study. In an embodiment, the method may include reallocating computing resources during the transfer of the medical study.

Certain embodiments of an adaptable medical image data transfer system include at least one medical study comprising at least one medical image and a plurality of computing resources for transferring medical data, wherein the plurality of computing resources is allocated among the at least one medical study based on a number of images in each of the at least one medical study. In an embodiment, the plurality of computing resources is dynamically allocated based on the number of images in each of the at least one medical study. In an embodiment, the plurality of computing resources is dynamically allocated based on the relative image count of each of the at least one medical study.

The system may also include a storage device for storing transferred medical data. The storage device may include a medical evidence archive, a redundant array of independent disks (RAID), and/or a storage area network, for example. The system may also include a digital medium capable of transferring the at least one medical study at least one of to and from a digital storage. The digital medium may transfer the at least one medical study according to DICOM protocol, for example.

In certain embodiments, computing resources are allocated among one or more medical image studies using allocation priorities assigned to the studies. The allocation priorities may be determined based on a number of images (i.e., image count) in each of the medical image studies and an amount of computing resources already allocated to the medical image studies. In an embodiment, the allocation priorities are further determined using start times associated with processing of each of the medical image studies for transfer.

Certain embodiments include a computer-readable storage medium including a set of instructions for a computer. The set of instructions includes a count routine for determining a relative image count for a medical study, an allocation routine for allocating available computing resources for the medical study based on the relative image count, and a transmission routine for transmitting the medical study using the allocated computing sources. In an embodiment, the allocation routine is capable of dynamically reallocating the available computing resources. In an embodiment, the allocation routine dynamically allocates available computing resources for a plurality of medical studies based on the relative image counts of the medical studies. In an embodiment, the transmission routine is configured to transmit the medical study at least one of to and from a digital storage via a communication link, for example.

### BRIEF DESCRIPTION OF SEVERAL VIEWS OF THE DRAWINGS

FIG. 1 illustrates an image management and communication system used in accordance with an embodiment of the present invention.

FIG. 2 illustrates an exemplary Picture Archiving and Communication System (PACS) system in accordance with an embodiment of the present invention.

FIG. 3 illustrates a medical image file system used in accordance with an embodiment of the present invention.

FIG. 4 illustrates a flow diagram for a method for improved transfer of medical image data in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

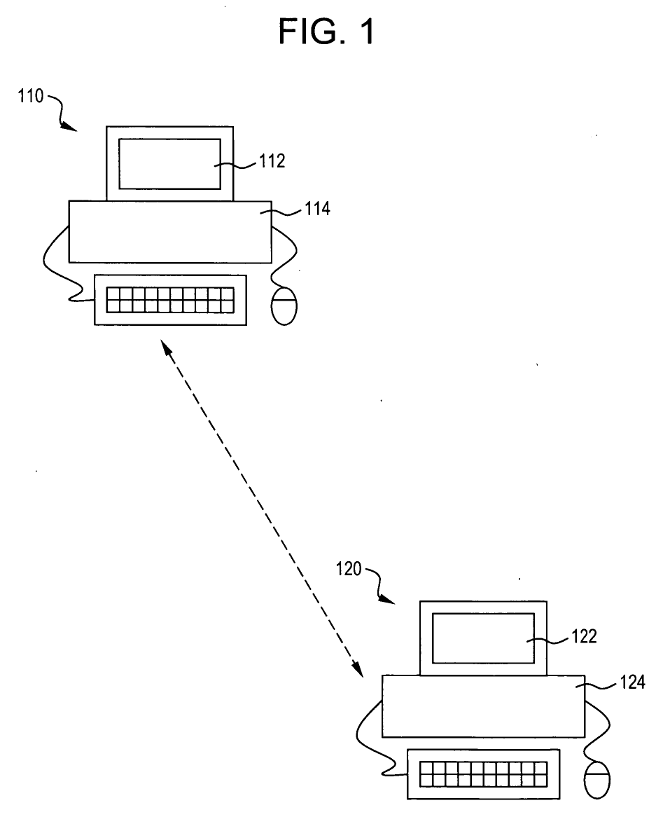

FIG. 1 illustrates an image and information management system 100 used in accordance with an embodiment of the present invention. The image and information management system 100 includes a plurality of workstations 110, 120. The system 100 may be one or more of a plurality of medical information systems. In an embodiment, the image and information management system 100 is a picture archiving and communication system (PACS) including a plurality of PACS workstations.

The image and information management system 100 is capable of performing image management, image archiving, exam reading, exam workflow, and/or other medical enterprise workflow tasks, for example. In an embodiment, the system 100 is or includes a PACS, for example. The system 100 may also include a healthcare or hospital information system (HIS), a radiology information system (RIS), a clinical information system (CIS), a cardiovascular information system (CVIS), a library information system (LIS), order processing system, and/or an electronic medical record (EMR) system, for example. The image management system 100 may include additional components such as an image manager for image management and workflow and/or an image archive for image storage and retrieval.

The image and information management system 100 may interact with one or more modalities, such as an x-ray system, computed tomography (CT) system, magnetic resonance (MR) system, ultrasound system, digital radiography (DR) system, positron emission tomography (PET) system, single photon emission computed tomography (SPECT) system, nuclear imaging system, and/or other modality. The image and information management system 100 may acquire image data and related data from the modality for processing and/or storage.

In an embodiment, the workstations 110, 120 include interfaces 112, 122 capable of allowing control of and exchange of information at the workstation 110, 120. The interface 112, 122 may be a graphical user interface (GUI) or other user interface that may be configured to allow a user to access functionality at the workstation 110, 120. The interface 112, 122 may be connected to an input device, such as a keyboard, mousing device, and/or other input device, for example.

Additionally, the workstations 110, 120 may include communication devices 114 and 124, respectively, to allow communication between the workstations 110, 120 and/or other external systems, for example. The communication devices 114, 124 may include a modem, wireless modem, cable modem, Bluetooth™ wireless device, infrared communication device, wired communication device, and/or other communication device, for example. The communication devices 114, 124 communicate and transfer data via one or more communication protocols, such as the DICOM protocol. The communication devices 114, 124 coordinate with processors in the workstations 110, 120 to establish a connection between the workstations 110, 120 and remotely execute functionality and/or transfer data, for example.

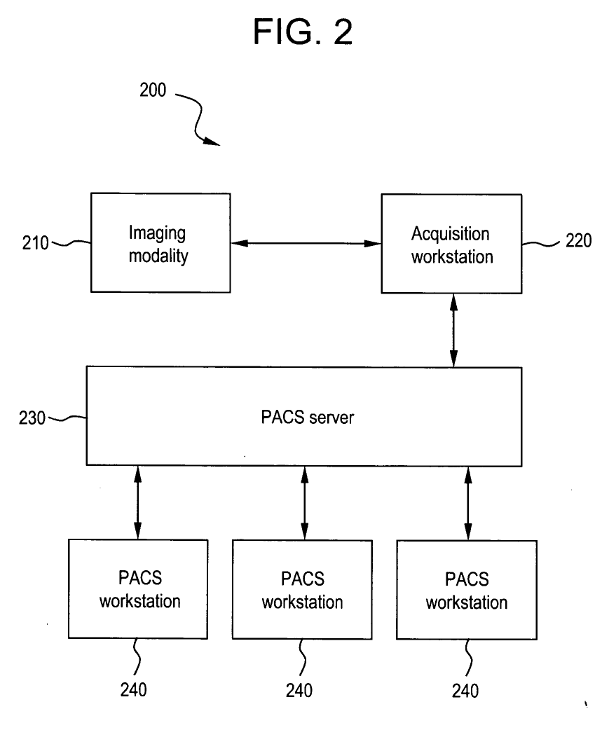

FIG. 2 illustrates an exemplary Picture Archiving and Communication System (PACS) system 200 in accordance with an embodiment of the present invention. The PACS system 200 includes an imaging modality 210, an acquisition workstation 220, a network server 230, and one or more display workstations 240. The system 200 may include any number of imaging modalities 210, acquisition workstations 220, network servers 230 and display workstations 240 and is not in any way limited to the embodiment of system 200 illustrated in FIG. 2.

In operation, the imaging modality 210 obtains one or more images of a patient anatomy. The imaging modality 210 may include any device capable of capturing an image of a patient anatomy such as a medical diagnostic imaging device. For example, the imaging modality 210 may include an X-ray imager, ultrasound scanner, magnetic resonance imager, or the like. Image data representative of the image(s) is communicated between the imaging modality 210 and the acquisition workstation 220. The image data may be communicated electronically over a wired or wireless connection, for example.

In an embodiment, the acquisition workstation 220 may apply one or more preprocessing functions to the image data in order to prepare the image for viewing on a display workstation 240. For example, the acquisition workstation 220 may convert raw image data into a DICOM standard format or attach a DICOM header. Preprocessing functions may be characterized as modality-specific enhancements, for example (e.g., contrast or frequency compensation functions specific to a particular X-ray imaging device), applied at the beginning of an imaging and display workflow. The preprocessing functions may differ from processing functions applied to image data in that the processing functions are not modality specific and are instead applied at the end of the imaging and display workflow (for example, at a display workstation 240).

The image data may then be communicated between the acquisition workstation 220 and the network server 230. The image data may be communicated electronically over a wired or wireless connection, for example.

The network server 230 may include computer-readable storage media suitable for storing the image data for later retrieval and viewing at a display workstation 240. The network server 230 may also include one or more software applications for additional processing and/or preprocessing of the image data by one or more display workstations 240, for example.

One or more display workstations 240 are capable of or configured to communicate with the server 230. The display workstations 240 may include a general purpose processing circuit, a network server 230 interface, a software memory, and/or an image display monitor, for example. The network server 230 interface may be implemented as a network card connecting to a TCP/IP based network, but may also be implemented as a parallel port interface, for example.

The display workstations 240 may retrieve or receive image data from the server 230 for display to one or more users. For example, a display workstation 240 may retrieve or receive image data representative of a computed radiography (CR) image of a patient's chest. A radiologist may then examine the image for any objects of interest such as tumors, lesions, etc.

The display workstations 240 may also be capable of or configured to apply processing functions to image data. For example, a user may desire to apply processing functions to enhance features within an image representative of the image data. Processing functions may therefore adjust an image of a patient anatomy in order to ease a user's diagnosis of the image. Such processing functions may include any software-based application that may alter a visual appearance or representation of image data. For example, a processing function can include any one or more of flipping an image, zooming in an image, panning across an image, altering a window and/or level in a grayscale representation of the image data, and altering a contrast and/or brightness an image.

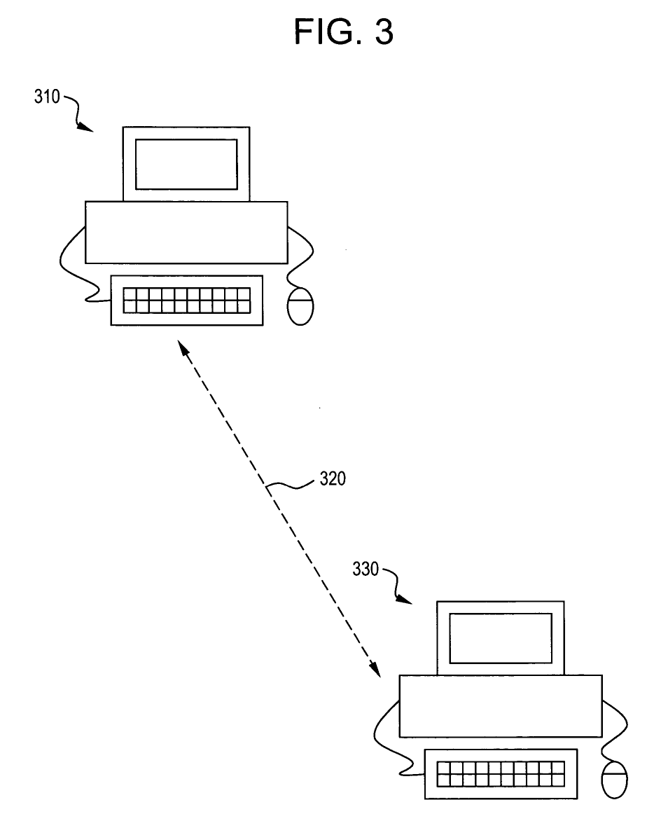

FIG. 3 illustrates a medical image file system 300 used in accordance with an embodiment of the present invention. The system 300 includes a medical image data source 310, a communication link 320, and a medical image data storage device 330. The medical image data source 310 includes a plurality of medical image files 312, 313, 314 organized into series and/or studies, for example.

In an embodiment, the medical image data source 310 may include a hospital information system (HIS), a radiology information system (RIS), a clinical information system (CIS), a cardiovascular information system (CVIS), a picture archiving and communication system (PACS), a library information system (LIS), an electronic medical record (EMR) system, and/or other image and information management system, for example. The communication link 320 may include a wireless communication link, such as a Bluetooth™ wireless communication link, a wired communication link, an infrared communication link, a cable communication link, an Internet communication link, a virtual private network, and/or other communication link, for example. The medical image data storage device 330 may be a long term and/or short term storage system, for example. The storage device 330 may include a picture archiving and communication system (PACS), long term storage archive (e.g., Centricity® Enterprise Archive), a redundant array of independent disks (RAID), a storage area network, a network attached storage (NAS), an advanced intelligent tape (AIT), magneto-optical storage discs, content address based storage (CAS), and/or other image data storage, for example.

In an embodiment, a medical study includes a set of one or more medical images of a subject, such as a patient. Medical images may include x-ray images, computed tomography (CT) images, ultrasound images, magnetic resonance (MR) images, digital radiography (DR) images, and/or other images, for example. A medical study transfer is a transfer of multiple medical image files, for example. Transfer overhead of a medical study is time spent on computation before, during and after raw data is transferred across a digital medium to and from a digital storage solution. Each image is associated with a single transaction in an image file transfer. A single transaction adds overhead to the transfer. Thus, the transfer overhead of a DICOM image study increases as an amount of images contained in the DICOM study increases, for example. For example, a study with 1000 small images with total size X will take longer to transfer than a study with a single image of size X. Similarly, transfer computation power demands increase as the number of images to be transferred increases.

A relative image count is a quantitative comparison between numbers of medical images contained in a plurality of medical studies. For example, a medical study in transfer has a high relative image count when no other studies are transferred or when other studies in transfer have a lower image count. The image count of a study is relatively low when other studies in transfer have a higher image count, for example. For example, a medical image study including 100 images has a higher relative image count than a medical study including 10 images.

A computing resource is a process that transfers one image file of a study at a time. A computing resource may include a memory, memory allocation, a processor, processor allocation, a processing thread, transfer bandwidth, or other resource, for example. Computing resources may be found in the medical image data source 310, the communication link 320, and/or the medical image data storage device 330. Multiple computing resources may be associated with a single study transfer. An amount of computing resources available to a digital storage solution is configurable.

In an embodiment, for medical studies in transfer with a relatively low image count, a time to initiate and complete a transmission (i.e., transfer overhead) is small compared to raw data transfer time. However, for a DICOM study with a relatively high image count, the overhead of transmission is large compared to the raw data transfer time. If the raw data transfer time is constant over time for a given file, the transfer overhead is a variable in the equation.

In an embodiment, the transfer overhead of a DICOM image study from the medical image data source 310 to the medical image data storage device 330 via the communication link 320 is reduced when transfer of a study with a high relative image count receives more computing resources than the transfer of a study with a low relative image count. Transfer overhead of a DICOM study may also be reduced when computing resources are re-distributed upon completion and/or initiation of a study transfer, for example. Additionally, transfer overhead may be improved if a medical image study transfer consumes at least one computing resource, for example. In an embodiment, larger image studies are identified, and more computing resources are allocated to transfer the larger image studies than to transfer smaller image studies. Smaller image studies may have better throughput in transfer.

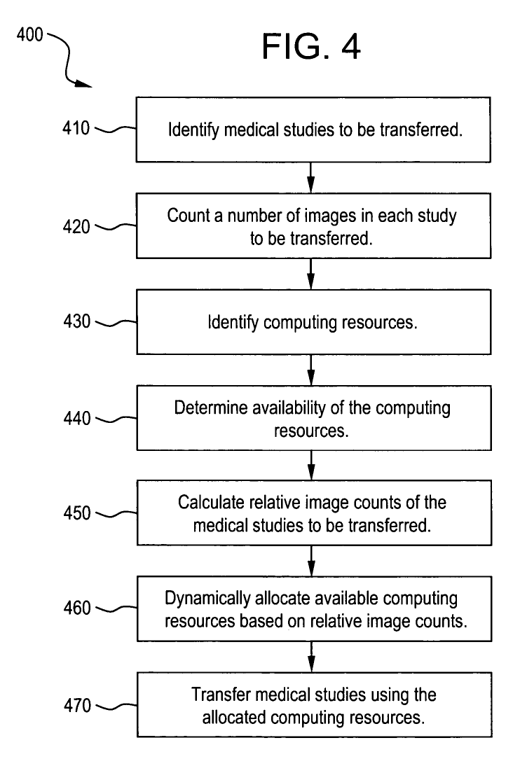

FIG. 4 illustrates a flow diagram for a method 400 for improved transfer of medical image data in accordance with an embodiment of the present invention. First, at step 410, medical image studies to be transferred are identified. For example, a PACS may include a CT study, an x-ray study, and an ultrasound study for a patient to be transferred to long term storage. A processor and software at the medical image data storage device 330 and/or the medical image data source 310 may determine one or more studies in one or more directories or other storage to be transferred between the source 310 and the storage device 330. A user at the storage device 330 and/or the source 310 may also identify the study or studies to be transferred, for example. Then, at step 420, a number of images in each study is counted. For example, a processor and software the medical image data storage device 330 and/or the medical image data source 310 count the number of images in each study to be transferred.

At step 430, computing resources in the system are identified. For example, the storage device 330 and/or the source 310 identify the computing resources present in the system 300. Then, at step 440, availability of the computing resources is determined. For example, the storage device 330 and/or the source 310 determine whether each of the computing resources in the system 300 is available or is being used for data transfer or other operation. Available computing resources are identified or “marked” as available for image data transfer. Occupied resources are not used in an image data transfer determination. In an embodiment, determination of resource availability is a dynamic process, and, when a computing resource has been freed from performing another operation, the resource is added to the pool of computing resources available for medical study data transfer.

Next, at step 450, relative image counts among the medical image studies are calculated. For example, suppose three medical image studies (A, B, C) are to be transferred from the data source 310 to the data storage 330. Medical image study A includes 10 images, medical image study B includes 20 images, and medical image study C includes 30 images, for example. Then, medical image study A may be assigned a relative image count of 1, for example, since medical image study A has the smallest image count. Medical image study B may be assigned a relative image count of 2, for example, since medical image study B includes twice the number of images in study A. Alternatively, medical image study B may be assigned a relative image count of 10, for example, since study B includes 10 more images than study A. Similarly, medical image study C may be assigned a relative image count of 3 or 20, for example.

Then, at step 460, available computing resources are dynamically allocated based on relative image counts of the studies to be transferred. For example, a medical image study with a higher relative image count is allocated a greater number of available computing resources than a study with a lower relative image count. In an embodiment, a medical image study is allocated computing resources in proportion to its relative image count. For example, medical study C is allocated three times the number of computing resources allocated to medical study A because medical study C includes three times the number of images as in medical study A. In an embodiment, a priority is determined for each medical image study to be transferred based on image count, allocated resource(s) and/or processing start time, for example, for use in allocating computing resources.

For example, suppose 60 computing resources are available for image data transfer in the system 300. Computing resources may be allocated as follows based on the relative image counts of the three medical image studies to be transferred: 60=X+2X+3X, where X=10 is a base number of computing resources allocated to transfer an image study. More generally,

Available Computing Resources=Base Resource Allocation

$$Available Computing Resources = Base Resource Allocation * {\sum }_{n = 1}^{z} {S}_{z} , \qquad ( 1 )$$

where z indicates the number of medical image studies to be transferred and S_{z} indicates the relative image count for each of the studies. In an embodiment, the system 300 rounds fractional computing resources to whole computing resources in favor of a medical study with a higher relative image count. In another embodiment, computing resources may be fractionally allocated to one or more medical image studies.

At step 470, medical image studies are transferred using the allocated computing resources. For example, image studies are transferred from the medical image data source 310 to the medical image data storage device 330 via the communication link 320 for long-term storage at the storage device 330. In an embodiment, computing resources allocated for transfer of a medical image study are repeatedly used for transfer of that study until transfer is complete. In an embodiment, computing resources no longer being used for transfer of a medical image study may return to the pool of available computing resources for re-allocation to another medical study for transfer.

For example, if several medical image studies are competing for resources to be transferred, the study with highest priority is allocated an unallocated resource. If two or more studies have equal priority, then the study that was registered for processing first is allocated the unallocated resource. Priority may be assigned using a variety of schemes or conventions, for example. For example, if a number of allocated threads (or other computing resources) for a study is greater than zero, then a priority for the study may be calculated using the study's image count divided by the number of allocated threads for the study. If a number of allocated threads (or other computing resources) for a study is zero, then a priority for the study may be set to maximum priority, for example.

As an example, studies A, B and C are to be transferred. Study A has an image count of 1500; study B has an image count of 1000; and study C has an image count of 10. Studies A, B and C were registered for processing at times T1, T2 and T3, respectively, where T1<T2<T3. Studies A, B and C are processed simultaneously. If study A has been allocated ten threads, the priority for study A is 150 (1500/10=150). If study B has been allocated 2 threads, the priority for study B is 500 (1000/2=500). If study C has been allocated zero threads, the priority for study C is MAX. In this example, study C has the highest priority, and an unallocated resource (e.g., a thread) is allocated to study C. However, if studies A, B and C have all been allocated zero threads, then all three studies have identical priority. An unallocated resource (e.g., a thread) is allocated to study A, the first study to have started processing at time T1. If study A has been allocated five threads, the priority for study A is 300 (1500/5=300). If study B has been allocated two threads, the priority for study B is 500 (1000/2=500). If study C has been allocated 1 thread, the priority of study C is 10 (10/1=10). In this example, study B has the highest priority, and an unallocated resource (e.g., a thread) is allocated to study B.

Thus, certain embodiments provide an improved system and method for reducing total transfer overhead of medical evidence data transfer by selectively allocating computing resources. Certain embodiments provide dynamic allocation of computing resources for transfer of medical image files. Certain embodiments increase efficiency of storage and retrieval of medical evidence study data by helping to optimize use of network and storage resources based on medical evidence data characteristics. Certain embodiments improve storage throughput for medical image data storage devices based on medical evidence data properties. In certain embodiments, transfer optimization operates independent of the storage device upon which the data resides.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for improved transfer of medical image data, said method comprising:
determining an image count for a medical study including one or more images;
comparing the image count for the medical study to image counts for other medical studies to be transferred to calculate a relative image count;
identifying availability of computing resources;
allocating available computing resources to the medical study based on the relative image count; and
transferring the medical study using the allocated computing resources.

2. The method of claim 1, wherein said allocating step further comprises allocating more computing resources to a medical study with a high relative image count than to a medical study with a low relative image count.

3. The method of claim 1, wherein said allocating step further comprises selectively allocating available computing resources based on relative image count to reduce transfer overhead.

4. The method of claim 1, wherein said transferring step further comprises transferring the medical study for storage.

5. The method of claim 1, wherein said transferring step further comprises transferring the medical study for display.

6. The method of claim 1, further comprising determining an allocation priority for the medical study based on the relative image count and computing resources already allocated to the medical study and allocating available computing resources to the medical study based on the allocation priority.

7. The method of claim 6, further comprising determining the allocation priority using a start time associated with processing of the medical study for transfer.

8. The method of claim 1, further comprising reallocating computing resources upon completion of the transfer of the medical study.

9. The method of claim 1, further comprising reallocating computing resources during the transfer of the medical study.

10. An adaptable medical image data transfer system, said system comprising:
at least one medical study comprising at least one medical image; and
a plurality of computing resources for transferring medical data, wherein the plurality of computing resources is allocated among the at least one medical study based on a number of images in each of the at least one medical study.

11. The system of claim 10, wherein said plurality of computing resources is dynamically allocated based on the number of images in each of the at least one medical study.

12. The system of claim 10, wherein said plurality of computing resources is dynamically allocated based on the relative image count of each of the at least one medical study.

13. The system of claim 10, further comprising a storage device for storing transferred medical data.

14. The system of claim 10, wherein the plurality of computing resources is allocated among the at least one medical study using at least one allocation priority assigned to each of the at least one medical study, wherein the at least one allocation priority is determined based on the number of images in each of the at least one medical study and computing resources already allocated to each of the at least one the medical study.

15. The system of claim 14, wherein the at least one allocation priority is further determined using at least one start time associated with processing of each of the at least one the medical study for transfer.

16. The system of claim 10, further comprising a digital medium capable of transferring the at least one medical study at least one of to and from a digital storage.

17. A computer-readable storage medium including a set of instructions for a computer, the set of instructions comprising:
a count routine for determining a relative image count for a medical study;
an allocation routine for allocating available computing resources for the medical study based on the relative image count; and
a transmission routine for transmitting the medical study using the allocated computing sources.

18. The set of instructions of claim 17, wherein said allocation routine is capable of dynamically reallocating the available computing resources.

19. The set of instructions of claim 17, wherein said allocation routine dynamically allocates available computing resources for a plurality of medical studies based on the relative image counts of the medical studies.

20. The set of instructions of claim 17, wherein said transmission routine is configured to transmit the medical study at least one of to and from a digital storage via a communication link.

21. The set of instructions of claim 17, wherein said allocation routine allocates available computing resources for the medical study using an allocation priority assigned to the medical study, wherein the allocation priority is determined based on the relative image count for the medical study and a number of computing resources already allocated to the medical study.
